(19) United States
(12) Patent Application Publication
(10) Pub. No.: US 2022/0341658 A1
(43) Pub. Date: Oct. 27, 2022

(54) SYSTEM FOR EVALUATING THE INSULATION PROPERTIES OF A THERMALLY INSULATED TRANSPORT UNIT

(71) Applicant: BASF SE, Ludwigshafen am Rhein (DE)

(72) Inventors: Andreas Wollny, Ludwigshafen am Rhein (DE); Frank Beham, Ludwigshafen (DE); Mathias Weickert, Ludwigshafen (DE); Carl Spoerri, Zuerich (CH)

(73) Assignee: BASF SE, Ludwigshafen am Rhein (DE)

(21) Appl. No.: 17/764,647

(22) PCT Filed: Sep. 28, 2020
(86) PCT No.: PCT/EP2020/077086

§ 371 Date: Mar. 29, 2022

(30) Foreign Application Priority Data
Sep. 30, 2019 (EP) 19200369.7

(51) Int. Cl. F25D 29/00; F25D 3/06

(52) U.S. Cl. CPC F25D 29/003; F25D 3/06; F25D 29/008

(57) ABSTRACT

A system for evaluating insulation properties of a thermally insulated transport unit contains at least one thermally insulated transport unit for transporting and/or storing goods. The thermally insulated transport unit contains at least one temperature sensor configured to provide actual temperature data of the temperature within the thermally insulated transport unit. The system also includes at least one evaluation component for evaluating the insulation properties, at least based on a comparison of actual temperature data and calculated temperature data based on a thermal model of the thermally insulated transport unit.

### FIELD OF THE INVENTION

The present invention relates to a system for evaluating the insulation properties of a thermally insulated transport unit, the use of evaluation means in such a system, the use of a thermally insulated transport unit in such a system and the use of calculated temperature data in such a system.

### BACKGROUND OF THE INVENTION

Thermally insulated transport units, e.g. transport boxes, are well known in the prior art and are used in a wide variety of designs and sizes. For example, such thermally insulated transport units are used for the transportation of temperature sensitive goods, e.g. in the pharmaceutical or medical sector, wherein during transportation, it has to be ensured that the shipped goods, e.g. vaccines, stay in a certain temperature band, e.g. between 2 and 8° C. For this purpose, both so-called passive or active insulation boxes are used. In contrast to passive boxes, active boxes include electric cooling units, whereas passive boxes include phase change material (PCM) as cooling capacity. At present, passive boxes are gaining relative market share due to the higher flexibility in operations compared to active boxes with an electric cooling unit, e.g. compressor, requiring electric power.

However, the multiple use of passive boxes for temperature controlled shipments is problematic, as the quality of these boxes after a trip cannot be judged reliably from the outside appearance alone. The most sensitive part of high-quality transport boxes are vacuum insulation panels, so-called VIPs, usually used as one of several insulation layers. Such vacuum insulation panels are under vacuum and even small but most times invisible damages can lead to a dramatic loss of performance of the insulation.

Therefore, these passive boxes are often discarded after only one use, even though the performance of the passive boxes would still be sufficient for more trips. In todays operation, there are two ways of dealing with that issue. Some companies already use passive boxes multiple times without exact knowledge of the condition and thus taking risk of failure. Other companies use passive boxes with a metal blank integrated into the vacuum insulation panels but need to manually check the performance what is labor intense and time consuming.

In view of this, it is found that a further need exists to provide a more reliable, faster, and less costly system for evaluating the insulation properties of a thermally insulated transport unit.

### SUMMARY OF THE INVENTION

In the view of the above, it is an object of the present invention to provide a system for evaluating the insulation properties of a thermally insulated transport unit in a more reliable, faster and less costly manner.

These and other objects, which become apparent upon reading the following description, are solved by the subject matter of the independent claims. The dependent claims refer to preferred embodiments of the invention.

According to the invention, a system for evaluating the insulation properties of a thermally insulated transport unit is provided comprising: at least one thermally insulated transport unit for transporting and/or storing goods, wherein the thermally insulated transport unit comprises at least one temperature sensor means configured to provide actual temperature data of the temperature within the thermally insulated transport unit; further comprising at least one evaluation means for evaluating the insulation properties at least based on a comparison of actual temperature data and calculated temperature data based on a thermal model of the thermally insulated transport unit.

In other words, the present invention proposes to evaluate the insulation properties of a specific transport unit by comparing a measured actual temperature with a calculated/expected temperature based on a temperature model of the used transport unit. The temperature model preferably provides temperature values and/or temperature value ranges, which are to be expected for a specific transport unit and, for example also for a specific transport route of the specific transport unit. If this comparison shows that the actual temperature deviates significantly from the calculated temperature, it can be assumed that the insulation of the transport unit is damaged and the transport unit is no longer suitable for further use or otherwise that the transport unit can be re-used for a further transport. Thus, the quality of a transport unit can be assessed by the comparison of a theoretical temperature curve (to-be) and the measurement of the actual temperature curve during a shipment (as-is). Based on the delta between the as-is and to-be curve, the quality of the box can be estimated and it is not necessary any more that an insulated transport unit has to be inspected before it is re-used, i.e. thereby the inspection effort can be avoided or at least reduced to a minimum. Moreover, based on the assessed quality of the transport unit, it can not only be determined that the transport box can be re-used at all, but also for which specific transports the transport unit can be re-used, e.g. in view of the transport conditions of a further transport, like the transport route, the transport duration, conditions to be expected during the further transport (temperature, humidity, etc.). Finally, based on the assessed quality of a transport unit, it is possible to estimate the durability and shelf-life of an insulated transport unit and/or to classify specific types of insulated transport units.

A thermally insulated transport unit can be any box, packaging, carton, etc. which is suitable to transport goods. In this context, it should be noted that the present invention is not limited to a specific thermally insulated transport unit, e.g. any active or passive thermally insulated transport unit. However, it is preferred that the thermally insulated transport unit is not a shipping container, but a box, packaging, carton, etc. The temperature sensor means can be provided by any means configured to measure the temperature within the transport box. Moreover, a temperature comparison can be made either continuously or at predetermined points in time whether regularly or randomly.

Preferably, the thermally insulated transport unit further comprises memory means for storing the actual temperature data. This allows to evaluate the temperatures measured during transport at the end of a transport or to prove that the temperature during transport was within a predetermined temperature range. So-called temperature loggers are used here in particular, which on the one hand are configured to measure the actual temperature and at the same time store these values in a memory unit.

It is further preferred that the thermally insulated transport unit further comprises at least one communication means configured to establish a communication with a separate computer unit and wherein the evaluation means are located in the separate computer unit. The separate computer unit is preferably a mobile computer device, e.g. a smartphone, a tablet, a notebook computer, a dashboard, etc. In this case, the communication means could be provided as Bluetooth, NFC or WLAN-interface configured for a short-range communication. However, it is also possible that the separate computer is located further away, in which case a suitable long-range communication interface can be used, such as a mobile radio interface. Alternatively or additionally also the thermally insulated transport unit further may comprise a computer unit, wherein in this case it is preferred that the evaluation means are located in the computer unit of the thermally insulated transport unit. Moreover, the communication means make it possible to provide real-time monitoring of the insulation properties of the transport unit.

Preferably, the insulation of the thermally insulated transport unit comprises at least one vacuum insulation panel (VIP), wherein the thermally insulated transport unit preferably further comprises cooling and insulation elements or layers and wherein the thermally insulated transport unit preferably further comprises phase change materials (PCM) as further cooling capacity. The VIP can be made from a variety of materials, wherein the materials are differentiated into materials of the core and materials of the foil (or film). The core material can be materials such as Polyurethane (PU) or EPS. High-performance insulating material is commercially available, for example, from BASF SE, Ludwigshafen, Germany, as SLENTITE. The foil can be a single layer foil or can be a multi-layer foil (of the same or of different materials). For example, the foil can be a metalized polymeric foil, or can be a polymeric foil without metallization. There are differences in properties such as gas permeability or water vapor diffusivity. There can be any combinations between core material and foil material. Notably, the present invention is not limited with respect to the insulation materials/layers of the insulated transport unit. In addition or alternatively to the use of VIPs, a variety of other materials or combinations thereof can be used such as plastics, card-board or paper, metal, composite material, expanded Polypropylene (EPP), expanded polystyrene (EPS) or the like.

It is preferred that the thermally insulated transport unit does not comprise any active cooling elements, i.e. that the thermally insulated transport unit is a so-called passive transport unit/box. Especially with passive transport boxes, it is common to dispose them after a single use. The present invention now allows to determine whether these passive boxes can be used multiple times, so that considerable waste avoidance and cost benefits can be achieved with the use of the present invention for passive boxes. Some company use passive boxes with a metal blank integrated into the vacuum insulation panels that allow for quality check of the panels. Due to manual handling, this procedure is labor intense and time consuming. So one more benefit is to have quality assessment based on data comparison (as-is vs. to-be) generated in operations without manual handling need. In particular, it is preferred that the thermally insulated transport unit does not comprise any cooling circuits, active controlled heat exchanger elements, compressors, expansion valves and the like, which provide active cooling. As a result, it is preferred that the thermally insulated transport unit does also not comprise means for controlling and/or regulating the temperature in the thermally insulated transport unit.

Preferably, the thermally insulated transport unit further comprises a position determining unit, preferably a Global Positioning System (GPS)) or by using a positioning determination algorithm based on signals in a Low-Power Wide-Area Network (LPWAN), wherein the position determining unit is preferably configured to allocate temperature data based on positioning information data. Thereby, the real-time monitoring of the insulation properties of the transport unit can be further improved, since the temperature data and the positioning information can be transmitted via the communication means, e.g. to a central computer device, cloud computer, etc.

It is further preferred that the thermally insulated transport unit comprises further sensor means configured to provide actual temperature data of the temperature outside of the thermally insulated transport unit, humidity data the thermally insulated transport unit is exposed to, acceleration data of the acceleration to which the insulated transport unit is exposed to and/or solar data of the duration and intensity of solar radiation. In this context, it is preferable that such data is also incorporated in the temperature model so that accuracy of the calculated temperature values can be improved.

Preferably, the evaluation means are configured to execute an evaluation algorithm, which is preferably based on the results of a machine-learning algorithm and/or an online simulation via Computational Fluid Dynamics (CFD) methods and/or a semi-empirically correlation and/or a calculation of the heat transfer considering phase change materials, engineer rules (for example VDI Wärmeatlas) and material properties like thermal conduction for determining the insulation properties of the thermally insulated transport unit.

To provide the evaluation algorithm based on a temperature model of a transport unit, the following steps can be taken, whereby the present invention is not limited to the following steps:
Providing data with respect to the geometric dimensions of the transport unit, e.g. by using a CAD file;
Describing material data such as heat conduction functions, insulation properties, heat capacity functions, battery data (phase transition enthalpy) or air data as a function of temperature/pressure via numerical fit functions or polynomials in the source code of the calculation program;
Linking/combining equations to be solved, like energy equation, pulse equation, continuity equation, activate;
Defining boundary conditions for the temperature in the environment and the box itself, impress wind speeds or the solar power input location-dependently; and
Calculating and observing the numerical convergence and stability according to the rule of numerics for computational fluid dynamics.

The heat transfer between the individual components of the box and their surroundings is calculated using the heat conduction equation. For this the densities, the heat conduction coefficients lambdaX and the heat capacities CpX of the materials are necessary. For the air, the viscosity and the Prandtl number are also required. By means of a Computational Fluid Dynamics (CFD) simulation the complete geometry and the environment can be calculated in detail in three dimensions and time. For this purpose, the flow and heat conduction equations as well as the energy equation are solved. The flow equations for the air represent the Navier-Stokes equations (impulse equations) and the continuity equation, which must be solved with the expert known solution approaches. In addition, the current state of the phase change material (PCM) as cooling capacity, e.g. cooling/cold packs, must be known regarding temperature and state of charge. The state of charge describes the heat to be added to bring the phase change material from solid to liquid (enthalpy at phase transition). Or if the phase change material is already liquid, how is the heat capacity of the phase change material and therefore the heating can be calculated by the heat conduction and energy equation.

In a reduced, simplified model, the spatiality may no longer be mapped. Points, at least one point per following component, are assumed for the phase change material, the inner insulation, the ambient air outside, the interior for the goods, the goods itself, which contain a substitute heat transfer to be calibrated, a substitute heat capacity, a possible phase transition with corresponding enthalpy and a substitute density.

Due to the initial temperatures, the simulation starts with the heat transfer between the components (or points). The heat transfer in the air is calculated by means of the Computational Fluid Dynamics simulation mentioned above or by means of a substitute model (at least one point per air volume). New temperatures (energy equation) result from the calculated heat flows. The heat loss of the phase change material, e.g. cooling pack, is considered by the state of charge. Depending on the state of charge, the temperature of the phase change material will change with a heat flow. Integration over time thus makes it possible to determine the overall time course of the temperature of the goods and that of the individual components of the box.

In case the evaluation algorithm is based on the results of a machine-learning algorithm, it is preferred that the machine-learning algorithm comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data higher by many orders of magnitude.

Preferably, the evaluation means are configured to issue an evaluation message indicating the insulation properties of the thermally insulated transport unit, wherein the message is at least one of the following messages: a recommendation message providing a recommendation about a further use of the thermally insulated transport unit, an alarm message indicating a critical loss of insulation capacity of the thermally insulated transport unit, an inspection message indicating that the thermally insulated transport unit has to be inspected by a service technician and/or an end of life message indicating the predicted time, preferably in minutes, until a failure occurs. In this respect, it is further preferred that the system comprises display and/or audio output means outputting the message of the evaluation means. The display and/or audio output means can be provided by a mobile computer, a central computer, a tablet computer, a smartphone, a dashboard, loudspeakers, lights, etc.

The present invention further refers to a use of evaluation means in a system as described above, wherein the evaluation system is configured to evaluate the insulation properties of the thermally insulated transport unit and preferably to issue an evaluation message indicating the insulation properties of the thermally insulated transport unit, a recommendation message providing a recommendation about a further use of the thermally insulated transport unit, an alarm message indicating a critical loss of insulation capacity of the thermally insulated transport unit, an inspection message indicating that the thermally insulated transport unit has to be inspected by a service technician and/or a suspension message indicating the predicted time, preferably in minutes, until a failure occurs and thus the time the box can be still used.

The present invention also relates to a use of a thermally insulated transport unit for transporting and storing goods comprising at least one temperature sensor means configured to provide actual temperature data of the temperature in the thermally insulated transport unit in a system as described above. In this respect, it is preferred that the thermally insulated transport unit is configured to transport temperature sensitive goods like medical and pharma products.

Moreover, the present invention also relates to a use of calculated temperature data based on a thermal model of a thermally insulated transport unit for evaluating the insulation properties of a thermally insulated transport unit in a system described above.

Finally, the present invention also relates to a method for providing information about the insulation properties of a thermally insulated transport unit in a system as described above comprising the steps of:
obtaining actual temperature data (as-is) of a thermally insulated transport unit;
providing calculated temperature data based on a thermal model of the thermally insulated transport unit (to-be);
comparing the actual temperature data and the calculated temperature data; and
providing information based on the comparison of the actual temperature data and the calculated temperature data.

### BRIEF DESCRIPTION OF THE DRAWINGS

In the following, the invention is described exemplarily with reference to the enclosed figure, in which

FIG. 1 is a schematic view of a system according to the preferred embodiment of the present invention.

### DETAILED DESCRIPTION OF EMBODIMENT

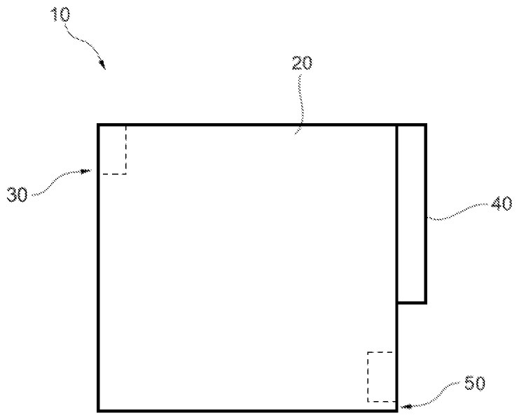

FIG. 1 is a schematic view of a system for evaluating the insulation properties of a thermally insulated transport 10 according to the preferred embodiment of the present invention.

The system 10 comprises a thermally insulated transport unit 20 for transporting and/or storing goods. In the preferred embodiment of the invention, the thermally insulated transport unit/box 20 is a so-called passive box comprising an outer material, an insulation layer and a phase change material (PCM) as cooling capacity. Such a thermally insulated transport unit 20 could be provided by a box, packaging, carton, etc. The height of such a thermally insulated transport unit 20 is preferably between 100 mm and 1200 mm, more preferably between 200 mm and 1000 mm and most preferably between 500 mm and 800 mm. The length and/or width of such a thermally insulated transport unit 20 is preferably between 100 mm and 1200 mm, more preferably between 200 mm and 1000 mm and most preferably between 500 mm and 800 mm.

But for the thermally insulated transport unit 20 also larger dimensions are possible. The thermally insulated transport unit 20 may be a container (unit load devices). For example, a container for airfreight has in particular a volume in the range of 1 m³ to 50 m³, preferably 1 to 30 m³, more preferably 1 to 20 m³, most preferably 1 to 15 m³.

Furthermore, the thermally insulated transport unit 20 is, for example, used as cooling container for clinical trial supply.

For example, the thermally insulated transport unit 20 in form of such a container has a height, length and/or width in the range of 50 cm to 500 cm, preferably 60 cm to 400 cm, more preferably 70 cm to 300 cm, most preferably 80 cm to 200 cm. However, the present disclosure is not limited to these preferred dimension, i.e. deviations from these dimensions are possible.

The thermally insulated transport unit 20 comprises at least one temperature sensor 30 in form of a so-called temperature logger 30 for capturing the actual temperature data within the thermally insulated transport unit 20. In the preferred embodiment, the temperature logger 30 also comprises memory means for storing the actual temperature data.

The system 10, here the thermally insulated transport unit 20, further comprises a computer unit 40, wherein the computer unit 40 hosts at least one evaluation means for evaluating the insulation properties of the thermally insulated transport unit 20 by comparing the actual temperature data provided by the temperature logger 30 and the calculated temperature data based on a thermal model of the thermally insulated transport unit 20. In this respect, the computer unit 40 is configured to execute a respective evaluation algorithm. As a result, the quality of the transport unit 20 can be assessed by the comparison of a theoretical/calculated temperature curve (to-be) and the measurement of the actual temperature curve during the shipment (as-is). Based on the delta between the as-is and to-be curve, the quality of the transport unit 20 can be estimated. Moreover, in the preferred embodiment, the evaluation means are also configured to issue an evaluation message indicating the insulation properties of the transport unit 20, wherein the message is at least one of the following messages: a recommendation message providing a recommendation about a further use of the transport unit 20, an alarm message indicating a critical loss of insulation capacity of the transport unit 20, an inspection message indicating that the transport unit 20 has to be inspected by a service technician and/or a suspension message indicating the time in minutes how long the transport unit 20 may still be used before failure occurs. These messages are preferably outputted on the display of the computer unit 40, wherein further output means like loudspeakers, lights, etc. may be provided at the transport unit 20.

In order to provide the evaluation algorithm based on a temperature model of the thermally insulated transport unit 20, the following steps can be taken:
Providing data with respect to the geometric dimensions of the transport unit 20, e.g. by using a CAD file;
Describing material data such as heat conduction functions, material constants, insulation properties, heat capacity functions, battery data (phase transition enthalpy) or air data as a function of temperature/pressure via numerical fit functions or polynomials in the source code of the calculation program;
Linking/combining equations to be solved, like energy equation, pulse equation, continuity equation, activate;
Defining boundary conditions for the temperature in the environment and the transport unit 20, impress wind speeds or the solar power input location-dependently; and
Calculating and observing the numerical convergence and stability according to the rule of numerics for computational fluid dynamics.

The heat transfer between the individual components of the transport unit 20 and their surroundings is calculated using the heat conduction equation. For this the densities, the heat conduction coefficients lambdaX and the heat capacities CpX of the materials are necessary.

For the air, the viscosity and the Prandtl number are also required. By means of a Computational Fluid Dynamics (CFD) simulation the complete geometry and the environment can be calculated in detail in three dimensions and time. For this purpose, the flow and heat conduction equations as well as the energy equation are solved. The flow equations for the air represent the Navier-Stokes equations (impulse equations) and the continuity equation, which must be solved with the expert known solution approaches. In addition, the current state of the phase change material (PCM) as cooling capacity, e.g. cooling/cold packs, must be known with regard to temperature and state of charge. The state of charge describes the heat to be added to bring the phase change material from solid to liquid (enthalpy at phase transition). Or if the phase change material is already liquid, how is the heat capacity of the phase change material and therefore the heating can be calculated by the heat conduction and energy equation. Due to the initial temperatures, the simulation begins with the heat transfer between the components (or points). The heat transfer in the air is calculated by means of the Computational Fluid Dynamics simulation mentioned above or by means of a substitute model (at least one point per air volume). New temperatures (energy equation) result from the calculated heat flows. The heat loss of the phase change material, e.g. cooling pack, is taken into account by the state of charge. Depending on the state of charge, the temperature of the phase change material will change with a heat flow. Integration over time thus makes it possible to determine the overall time course of the temperature of the goods and that of the individual components of the transport unit 20.

In the shown preferred embodiment, the transport box 20 further comprises a communication interface 50, e.g. a short-range or a long-range communication interface, like a Bluetooth, WLAN, mobile communication interface for establishing a data communication with further devices. Thereby, issued evaluation messages and/or the temperature data may also be transferred to a separate computer unit, like a mobile computer device, e.g. a smartphone, a tablet, a notebook computer, a dashboard, etc.

The present invention has been described in conjunction with a preferred embodiment as examples as well. However, other variations can be understood and effected by those persons skilled in the art and practicing the claimed invention, from the studies of the drawings, this disclosure and the claims.

In particular, the present invention is not limited to a specific location of the evaluation means, e.g. the evaluation means may be provided at the insulation unit 30 or at any other location. In the latter case, only respective communication interfaces have to be provided for a respective data exchange. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

10 system for evaluating the insulation properties of a thermally insulated transport

20 thermally insulated transport unit

30 temperature sensor/temperature logger

40 computer unit

50 communication interface

1. A system for evaluating the insulation properties of a thermally insulated transport unit, comprising:
at least one thermally insulated transport unit for transporting and/or storing goods, wherein the at least one thermally insulated transport unit comprises at least one temperature sensor means configured to provide actual temperature data of a temperature within the at least one thermally insulated transport unit; and
at least one evaluation means for evaluative the insulation properties of the at least one thermally insulated transport unit, at least based on a comparison of the actual temperature data and a calculated temperature data based on a thermal model of the at least one thermally insulated transport unit.

2. The system according to claim 1, wherein the at least one thermally insulated transport unit further comprises a memory means for storing the actual temperature data.

3. The system according to claim 1, wherein the at least one thermally insulated transport unit further comprises at least one communication means configured to establish a communication with a separate computer unit, and wherein the at least one evaluation means are located in the separate computer unit.

4. The system according to claim 1, wherein the at least one thermally insulated transport unit further comprises a computer unit, and wherein the at least one evaluation means are located in the computer unit of the at least one thermally insulated transport unit.

5. The system according to claim 1, wherein insulation of the at least one thermally insulated transport unit comprises at least one vacuum insulation panel (VIP).

6. The system according to claim 1, wherein the at least one thermally insulated transport unit does not comprise any active cooling elements.

7. The system according to claim 1, wherein the at least one thermally insulated transport unit further comprises a position determining unit.

8. The system according to claim 1, wherein the at least one thermally insulated transport unit comprises a further sensor means configured to provide:
actual temperature data of a temperature outside of the at least one thermally insulated transport unit,
humidity data of an air humidity the at least one thermally insulated transport unit is exposed to,
acceleration data of an acceleration to which the at least one insulated transport unit is exposed to, and/or
solar data of a duration and intensity of solar radiation the at least one thermally insulated transport unit is exposed to.

9. The system according to claim 1, wherein the at least one evaluation means are configured to execute an evaluation algorithm, for determining the insulation properties of the at least one thermally insulated transport unit.

10. The system according to claim 1, wherein the at least one evaluation means are configured to issue an evaluation message indicating the insulation properties of the at least one thermally insulated transport unit, wherein the evaluation message is at least one of the following messages:
a recommendation message providing a recommendation about a further use of the at least one thermally insulated transport unit,
an alarm message indicating a critical loss of insulation capacity of the at least one thermally insulated transport unit,
an inspection message indicating that the at least one thermally insulated transport unit has to be inspected by a service technician, and/or
a suspension message indicating a time for how long the at least one insulated transport unit can still be used until failure occurs.

11. The system according to claim 10, wherein the system further comprises a display and/or audio output means outputting the evaluation message of the at least one evaluation means.

12. A method, comprising:
configuring the system according to claim 1 to evaluate the insulation properties of the at least one thermally insulated transport unit.

13. A method, comprising:
transporting and storing goods in the at least one thermally insulated transport unit of the system according to claim 1, comprising the at least one temperature sensor means configured to provide actual temperature data of the temperature within the at least one thermally insulated transport unit.

14. The method according to claim 13, wherein the at least one thermally insulated transport unit is configured to transport medical and pharma products.

15. A method, comprising:
evaluating the insulation properties of the at least one thermally insulated transport unit in the system according to claim 1, based on the calculated temperature data based on the thermal model of the at least one thermally insulated transport unit.

16. The system according to claim 5, wherein the at least one thermally insulated transport unit further comprises cooling elements and/or phase change materials (PCM) as further cooling capacity.

17. The system according to claim 7, wherein the position determining unit is a Global Positioning System (GPS) or a position determining unit using a positioning determination algorithm based on signals in a Low-Power Wide-Area Network (LPWAN).

18. The system according to claim 7, wherein the position determining unit is configured to allocate temperature data based on positioning information data.

19. The system according to claim 9, wherein the at least one evaluation means is configured to execute the evaluation algorithm based on results of a machine-learning algorithm an online simulation via Computational Fluid Dynamics (CFD) methods; and/or a semi-empirical correlation and/or calculation of a heat transfer by considering phase change materials, engineer rules, and material properties.

20. The method according to claim 12, further comprising:
configuring the system to issue
an evaluation message indicating the insulation properties of the at least one thermally insulated transport unit,
a recommendation message providing a recommendation about a further use of the at least one thermally insulated transport unit,
an alarm message indicating a critical loss of insulation capacity of the at least one thermally insulated transport unit,
an inspection message indicating that the at least one thermally insulated transport unit has to be inspected by a service technician, and/or
a suspension message indicating a time for how long the at least one insulated transport unit can still be used until failure occurs.
